(19) United States
(12) Patent Application Publication
(10) Pub. No.: US 2016/0036923 A1
(43) Pub. Date: Feb. 4, 2016

(54) Efficient Migration of Application State Information

(71) Applicant: Microsoft Corporation, Redmond, WA (US)

(72) Inventors: Amar Phanishayee, Seattle, WA (US); Sharad Agarwal, Seattle, WA (US); James W. Mickens, Bellevue, WA (US); David A. Devecsery, Ann Arbor, MI (US)

(21) Appl. No.: 14/450,271

(22) Filed: Aug. 3, 2014

(51) Int. Cl. H04L 29/08

(52) U.S. Cl. CPC H04L 67/148; H04L 67/10

(57) ABSTRACT

Migration functionality is described herein for efficiently migrating application state information among user devices. The migration functionality operates by receiving factor information that describes a context in which a user is using an application on a first user device. For instance, the factor information may describe the manner in which the user has used the application on various user devices on prior occasions, together with characteristics of the user's current environment. The migration functionality then determines, based on the factor information, whether to transfer application state information from the first user device to at least a second user device. The application state information captures at least a dynamic runtime state of the application on the first user device. According to another illustrative aspect, the migration function is implemented in a manner that is agnostic with respect to the nature of the application that is being transferred and the nature of the application state information.

### BACKGROUND

Users may interact with the same application, at different times, using different user devices on which the application is installed; common user devices include smartphones, tablet-type computing devices, conventional stationary PCs, games consoles, and so on. For example, a user may interact with a game application using a smartphone while riding on a bus from work to home. Once at home, the user may resume interaction with the same application using a desktop PC. More specifically, once at home, the user may resume interaction with the application by restarting it anew, without reference to any of the operations that the user performed on the preceding user device.

### SUMMARY

Migration functionality is described herein for efficiently migrating application state information (ASI) from a first user device to at least a second user device. The migration functionality operates by receiving factor information that describes a context in which a user is using at least one application on the first user device. The migration functionality then determines, based on the factor information, whether to transfer application state information from the first user device to the second user device. Assuming that the transfer is deemed appropriate, the migration functionality then transfers the application state information from the first user device to the second user device using a selected communication mode.

The application state information captures at least the dynamic runtime state of the application on the first user device, at a specified point of capture of that state. From a user experience standpoint, the application state information allows the user to resume his or her interaction with the application on the second user device in a seamless manner, e.g., by creating the perception that the application has resumed from the same point at which its state was captured on the first user device.

According to one illustrative aspect, the factor information may include at least behavior-related information and/or environment-related information. The behavior-related information describes the behavior of the user in consuming the application on different respective user devices on prior occasions. The environment-related information describes the environmental conditions in which the user is currently using the application on the first user device. By leveraging the factor information, the migration functionality is able to transfer application state information among user devices in an intelligent manner, which, in turn, contributes to the efficient use of system resources.

According to another illustrative aspect, the migration functionality is implemented in a manner that is agnostic with respect to the nature of the application that is being run, and to the application state information that is created and transferred. Accordingly, the migration functionality can operate on any application, eliminating the need for an application developer to create ad hoc migration solutions for different respective applications.

The above approach can be manifested in various types of systems, devices, components, methods, computer readable storage media, data structures, graphical user interface presentations, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows an overview of an environment in which migration functionality is employed to transfer application state information among user devices.

FIG. 2 shows an example of a user experience that is provided upon transferring application state information from a first user device to a second user device.

FIG. 3 shows an instance of migration functionality that may be used in the environment of FIG. 1. The instance includes a sync component and an intelligence component.

FIG. 4 shows one manner in which the migration functionality, of FIG. 3, may be applied within a particular environment, according to one non-limiting implementation.

FIG. 5 shows one implementation of the sync component of FIG. 3.

FIG. 6 shows one implementation of the intelligence component of FIG. 3.

FIG. 7 shows one example of the operation of the intelligence component of FIG. 6.

FIG. 8 is a process which describes one manner of operation of the migration functionality that is provided by the environments of FIGS. 1 and 4.

FIG. 9 shows illustrative computing functionality that can be used to implement any aspect of the features shown in the foregoing drawings.

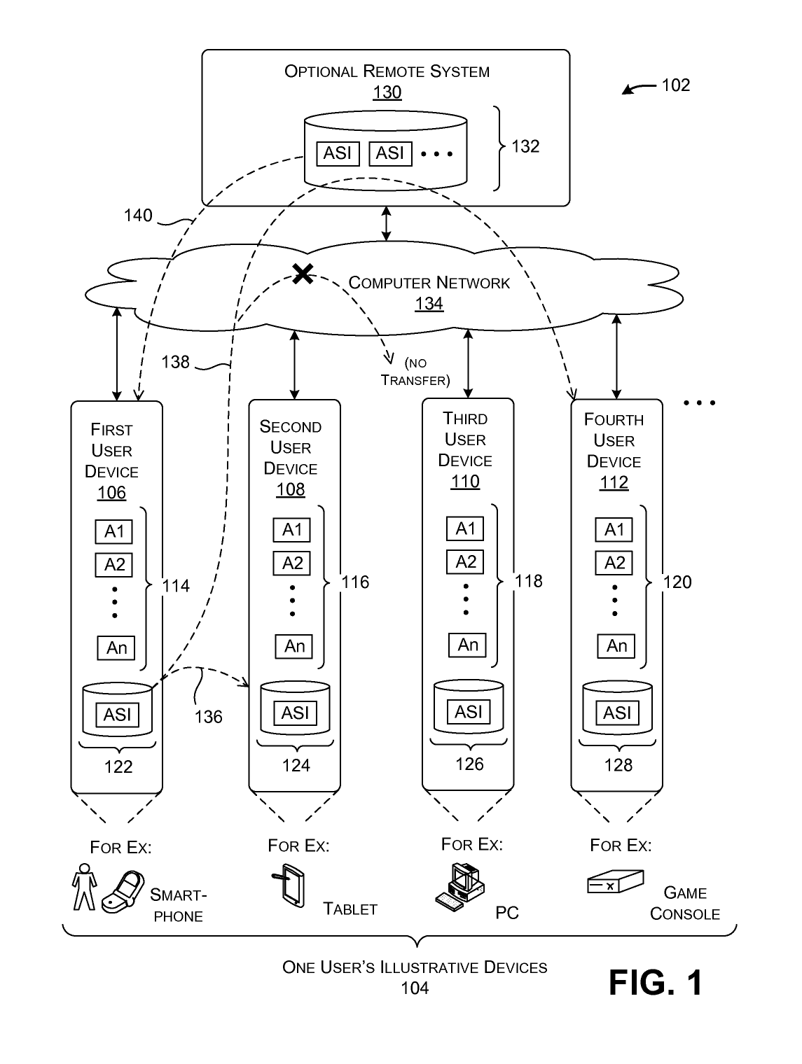

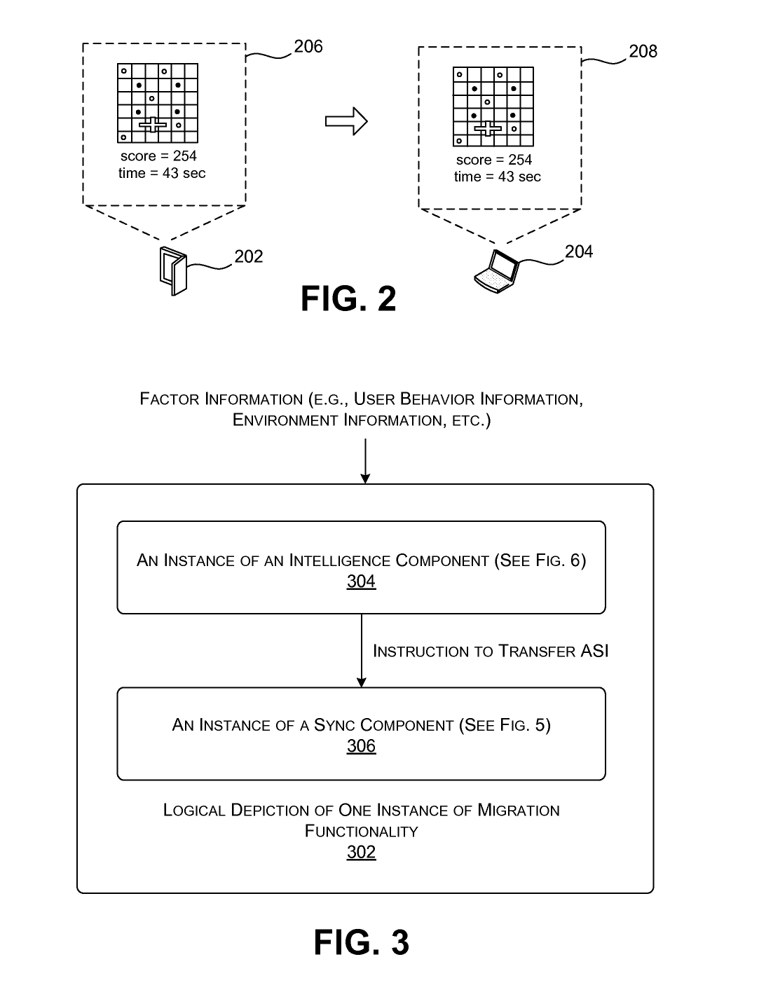

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes illustrative migration functionality for intelligently transferring application state information from a first user device to at least a second user device. Section B sets forth illustrative methods which explain the operation of the migration functionality of Section A. Section C describes illustrative computing functionality that can be used to implement any aspect of the features described in Sections A and B.

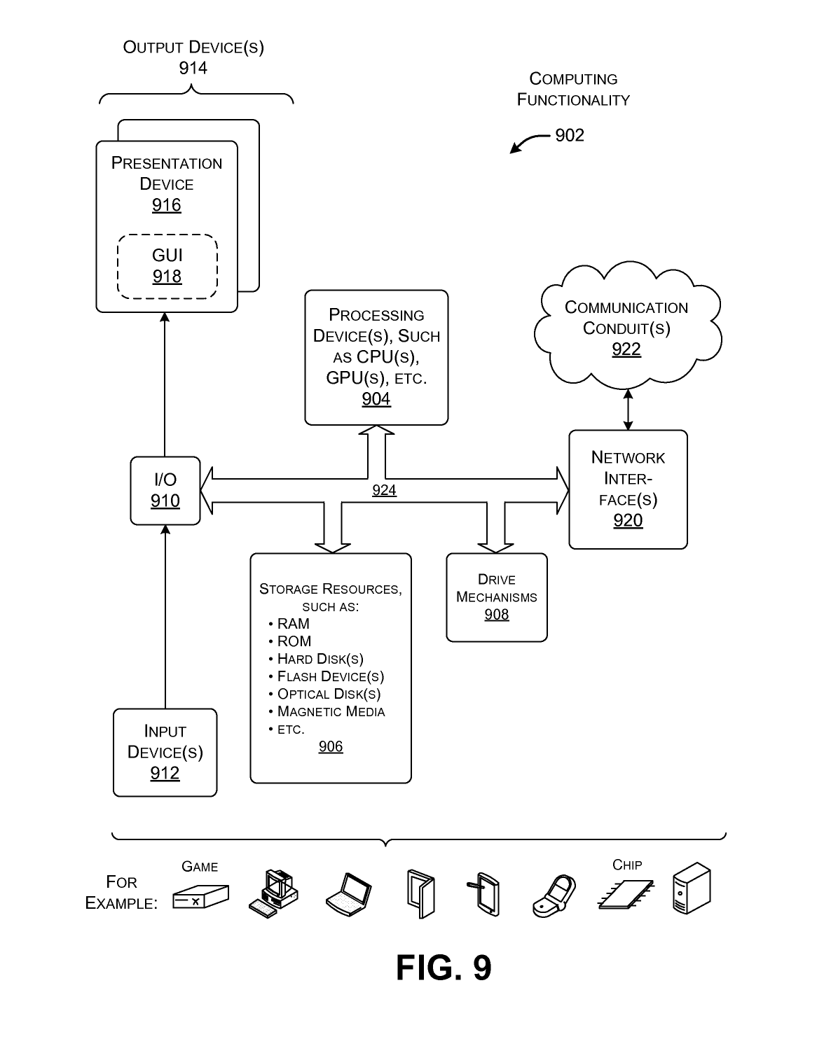

As a preliminary matter, some of the figures describe concepts in the context of one or more structural components, variously referred to as functionality, modules, features, elements, etc. The various components shown in the figures can be implemented in any manner by any physical and tangible mechanisms, for instance, by software running on computer equipment, hardware (e.g., chip-implemented logic functionality), etc., and/or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 9, to be described in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms, for instance, by software running on computer equipment, hardware (e.g., chip-implemented logic functionality), etc., and/or any combination thereof.

As to terminology, the phrase “configured to” encompasses any way that any kind of physical and tangible functionality can be constructed to perform an identified operation. The functionality can be configured to perform an operation using, for instance, software running on computer equipment, hardware (e.g., chip-implemented logic functionality), etc., and/or any combination thereof.

The term “logic” encompasses any physical and tangible functionality for performing a task. For instance, each operation illustrated in the flowcharts corresponds to a logic component for performing that operation. An operation can be performed using, for instance, software running on computer equipment, hardware (e.g., chip-implemented logic functionality), etc., and/or any combination thereof. When implemented by computing equipment, a logic component represents an electrical component that is a physical part of the computing system, however implemented.

The following explanation may identify one or more features as “optional.” This type of statement is not to be interpreted as an exhaustive indication of features that may be considered optional; that is, other features can be considered as optional, although not explicitly identified in the text. Further, any description of a single entity is not intended to preclude the use of plural such entities; similarly, a description of plural entities is not intended to preclude the use of a single entity. Further, while the description may explain certain features as alternative ways of carrying out identified functions or implementing identified mechanisms, the features can also be combined together in any combination. Finally, the terms “exemplary” or “illustrative” refer to one implementation among potentially many implementations.

A. Illustrative Migration Functionality

A.1. Overview

FIG. 1 shows an environment 102 in which migration functionality (illustrated in later figures) operates to efficiently migrate application state information among user devices 104. For example, FIG. 1 shows the illustrative and non-limiting case in which a single user owns and operates four user devices (106, 108, 110, 112). The first user device 106 corresponds to a smartphone, the second user device 108 corresponds to a tablet-type computing device, the third user device 110 corresponds to a stationary personal computer (PC), and the fourth user device 112 corresponds to a game console. However, the migration functionality can work with any number of user devices. Further, the collection of user devices 104 is not limited to the specific types of computing mechanisms shown in FIG. 1; for instance, the collection may also include book-reader devices, music-playing devices, wearable computing devices, electronic appliances, and so on.

Further, the collection of user devices 104 may include virtual devices (not shown in FIG. 1). Each virtual device corresponds to functionality that is hosted by a remote system, e.g., as implemented by a remote server or servers. The user may “own” the virtual device by virtue of establishing a user account on the remote system, and/or through some other provision. But the virtual device is not otherwise owned and manipulated by the user in the same sense as a physical computing device. For example, a user may have an account on a cloud storage site, which may be considered as a virtual device that is controlled by the user.

Note that, while FIG. 1 depicts the operation of the migration functionality as it applies to a single user who owns a particular collection of user devices 104, the migration functionality can provide the same service to plural users, each of whom owns or otherwise controls a collection of user devices.

The user devices 104 may use different processing architectures. For example, the first user device 106, corresponding to a smartphone, may use a first type of architecture (e.g., a reduced instruction set computing (RISC) architecture), while the third user device 110, corresponding to a stationary PC, may use a second type of architecture (e.g., an x86 architecture).

Each user device may store a collection of applications in a local data store. Each such application can perform any function or functions. For example, a first application may perform a gaming function, a second application may perform a search function, a third application may perform a map interaction function, and so on. At any given time, a user device may be running one or more of the applications that it stores.

More specifically, in one example, a user device may store an application by storing executable information which carries out the functions of the application. The executable information may include, for instance, executable files (EXEs), related files (e.g., dynamic linked libraries (DLLs)), and so on. The user device may use a local runtime system to run the application, that is, by operating on the executable information. In other cases, at least some of the functionality of an application may be hosted by a remote system, such as by the processing resources provided by a remote server or servers. In other cases, all of the functionality of an application may be hosted by a remote system; in that scenario, a user device which runs the application does not store any of the executable information for the application. However, to simplify explanation, it will henceforth be assumed that a user device stores at least some functionality associated with each application.

FIG. 1 specifically indicates that the first user device 106 provides a collection 114 of applications, the second user device 108 provides a collection 116 of applications, the third user device 110 provides a collection 118 of applications, and the fourth user device 112 provides a collection 120 of applications. For simplicity of illustration, the four user devices 104 are shown as hosting the same applications (e.g., applications A1-An). But more generally, the collections of applications provided by different user devices may vary, and, indeed, will likely vary for a typical user.

More specifically, while two different user devices may store the same application (e.g., on their respective local stores), the two instances of the applications need not be identical. For example, the executable files associated with an application that runs on a smartphone will likely differ, at least to some extent, from the executable files of the same application that runs on a stationary PC. Nevertheless, from the user's perspective, the two applications perform the same basic functions and provide the same general user experience.

The application state information (henceforth, “ASI” for brevity) may encompass different types of information regarding an application that is currently running on a first user device, with respect to an identified point in time (referred to below as the “capture time”). At least in part, the ASI may capture aspects of a running application that can potentially differ from one execution of the application to the next. For instance, in one implementation, as a minimum, the ASI of an application describes at least the dynamic runtime state of the application. In some cases, the ASI may also describe configuration settings that currently apply to the running application. In addition, or alternatively, the ASI may also describe data produced by the application, if any.

As a default assumption, the ASI does not contain the executable information associated with an application that does not vary from one execution of the application to the next, and/or other non-varying parts of the application. For instance, the executable information, which may be excluded from the ASI, may encompass the binaries associated with the application, such as its executable files (e.g., its EXEs), its DLLs, and so on. The migration functionality does not transfer the executable information because this is information that generally does not need to be reconstructed on the target user device. Rather, the target user device can resume the application based on the transferred ASI together with its own local version of the executable information. (As an aside, note that the executable information of the target user device may differ, to any extent, from the executable information of the source device, although these two instances of executable information pertain to the same application.) However, in some (albeit less common) cases described below, the migration functionality can also transfer executable information associated with the application to another user device, or to a virtual user device (e.g., a cloud storage device).

Jumping ahead momentarily in the sequence of figures, FIG. 2 provides an example that will serve as a vehicle for elaborating on the concept of ASI. In this example, a first user device 202 is currently running a game application. The migration functionality operates to capture ASI associated with the game application, and then transfer the ASI to a second user device 204. The ASI describes at least the dynamic runtime state of the game application at a capture time. In one case, the capture time corresponds to a time at which the running of the game application is suspended on the first user device 202. In another case, the capture time corresponds to any other identified time; that time need not correspond to the suspension of the application on the first user device 202 (meaning that the application may continue to run after the ASI has been captured on the first user device 202).

From a functional perspective, the dynamic runtime state provides whatever information is needed to provide a seamless user experience to the user as the user transitions from the first user device 202 to the second user device 204, while excluding information that does not need to be reconstructed on the second user device 204 (e.g., because the excluded information is static and is already available on the second user device 204). A seamless user experience, in turn, is produced by creating the perception that the game application is resumed on the second user device 204 from the same juncture in the programmatic flow of the application at which the ASI was captured on the first user device 202. For instance, assume that the game application provides a first user interface 206 on the first user device 202 at the capture time. Further assume that the game application provides a second user interface 208 at the time that the application is resumed on the second user device 204. A seamless user experience is produced when the user perceives that the information provided by the second user interface 208 is functionality equivalent to the information provided by the first user interface 206. However, because of the different form factors associated with the two devices (202, 204) and/or other factors, the user interfaces (206, 208) need not be exactly the same.

In one example, the dynamic runtime state may capture the positions of game pieces on a game board, the in-progress action being performed by the user (if any), the current play time, and so on. In another type of game application (not shown), the dynamic state may capture the positions of animated characters, the types of movements that the characters are performing, and so on. The type of dynamic state information that is stored is application-specific in nature and is determined, at least in part, by the application developer who creates the application for execution on a specified runtime system, so as to provide a desired suspend-and-resume experience (to be described below in greater detail). Hence, different applications may store different types of information to capture the dynamic runtime state. Subsection A.2 provides additional information regarding techniques for creating, storing, and transferring ASI.

The settings component of the ASI (if provided) refers to one or more parameter choices that control the running of the application on a user device. For example, the user of the game application shown in FIG. 2 may choose one or more settings which define the visual attributes of the game board, the behavior of the game board, the sound produced by the game application, the difficulty level of the game application, and so on. The data component of the ASI (if provided) refers to files and other information produced by an application. For example, the game application shown in FIG. 2 may produce an exportable file which stores statistical information associated with past game sessions.

The above collection of ASI components is cited by way of example, not limitation. To repeat, the ASI includes whatever information is necessary or appropriate to provide a seamless suspend-and-resume experience to the user across user devices—and thus, at a minimum, the ASI includes some dynamic runtime state information. And as stated, the ASI can exclude any information that is already available on the target user device.

It may also be instructive to describe the ASI that is transferred in the context of FIGS. 1 and 2 in the negative, that is, in terms of what it is not. (Note that such a description refers to illustrative implementations of the migration functionality, rather than outright prohibitions.) For instance, in illustrative implementations, the migration functionality refrains from sending the complete state of a user device. That complete state, as is commonly captured by virtual machine (VM) functionality within data centers, represents the complete state of the application, but also represents the complete state of the operating system, the underlying hardware resources, and any other functionality hosted by the user device. More formally stated, the migration functionality described herein may produce application state information that represents a part of a total amount of state information associated with a user device, the part being less than the total amount of state information. Further note that the migration functionality described herein does not require the use of a special runtime platform, such as virtual machine monitors, on the source and destination computing devices, as is the case with respect to traditional VM migration functionality. Rather, in one implementation, and as will be described in greater detail below, the migration functionality described herein leverages operating system support to suspend and resume applications, e.g., as provided in modern operating systems such as mobile operating systems and desktop operating systems, such as Microsoft® Windows® 8.

On the opposite extreme, the ASI does not simply provide selected pieces of metadata, such as the score of the game shown in FIG. 2, as is the case in some currently available roaming technologies. Such a limited amount of metadata is not sufficient to provide the seamless suspend-and-resume experience described above, and thus does not meet the above-described functional definition of ASI.

According to another illustrative aspect, the migration functionality operates in a manner that is agnostic with respect to the nature of the data that is expressed in an instance of ASI. That is, from the perspective of the migration functionality, an instance of ASI is simply a collection of data items that have been collected on a first user device and are sent to at least a second user device. In other words, in one implementation, the migration functionality is not specifically engineered to identify and interpret particular types of ASI data items that may differ from application to application; it stores and transfers whatever information that an application provides.

Furthermore, there is no need for an application developer to construct his or her application in a particular manner to make it compatible with the migration functionality. The application developer need only design the application such that it correctly interacts with its intended operating system to perform traditional suspend-and-resume operations on a single user device. And that is a task that the application developer would already perform. More specifically, in such a traditional suspend-and-resume operation, an operating system will invoke a suspend operation when the user shifts focus from an application to another application, or in low power states, and/or in other circumstances. The operating system will restore the application on the same user device when the user shifts focus back to the suspended application. In some implementations, the migration functionality described herein can leverage, at least in part, the same data that is stored in a traditional suspend-and-resume operation, without asking the application developer to create ad hoc and custom code to capture and interpret particular items of application state information.

Returning to FIG. 1, each user device may optionally include a local store for storing the ASI for an application. For instance, the user devices (106, 108, 110, 112) include respective data stores (122, 124, 126, 128) for storing instances of ASI. Each data store can use any type of data structure for storing ASI for a particular application. An instance of ASI for a particular application, captured at a particular capture time, may be conceptualized as an application container which stores the above-described components of the ASI, e.g., including dynamic runtime state information, setting information, data, etc.

The environment 102 may also include at least one optional remote system 130. The remote system 130 may be implemented by one or more servers. The remote system 130 may also provide at least one data store 132 for storing instances of ASI (for the illustrative purposes to be described below).

A computer network 134 of any type (or types) may communicatively couple the user devices 104 to the remote system 130. The computer network 134 may correspond to a wide area network (e.g., the Internet), a local area network, point-to-point links, and/or any combination thereof. The computer network 134 may be implemented using any combination of hardwired links, wireless links, etc. governed by any protocol or combination of protocols.

The computer network 134 may also provide a conduit that allows the user devices 104 to exchange instances of ASI with each other. In addition, or alternatively, the user devices 104 may include mechanisms for directly exchanging instances of ASI with each other in a peer-to-peer fashion. For example, at least some of the user devices 104 may include mechanisms for exchanging information via near field communication (NFC), Bluetooth™ communication, direct WiFi communication, wired communication of any type (e.g., USB, Ethernet, etc.), and so on.

Whatever communication path is used, as depicted in FIG. 1, the migration functionality operates to transfer the ASI of an application running on the first user device 106 to the corresponding application running (or soon to be run) on at least one other user device. The ASI enables the other user device to resume the running of the application from the same point at which the ASI was captured on the first user device 106, with no perceptible incongruence in application flow. In most of the examples described below, the other user device (which is the target or destination of the ASI) is a different physical device compared to the first user device 106 (which is the source of the ASI). But in other cases, the other user device is the same as the first user device 106. In that latter scenario, the first user device may transfer the ASI to a remote storage site (such as the remote data store 132), and then later retrieve it to resume the running of the application on the same user device.

More specifically, FIG. 1 shows a specific and non-limiting example in which the user is presumed to be running at least the application A1 on the first user device 106. At some juncture, the migration functionality transfers an instance of ASI pertaining to at least the application A1 to the second user device 108 and the fourth user device 112. More specifically, the migration functionality uses any type of direct communication technology to transfer the instance of the ASI from the first user device 106 to the second user device 108, as represented by path 136. In contrast, the migration functionality transfers the instance of the ASI from the first user device 106 to the fourth user device 112 via the remote system 130, as represented by path 138. For example, the data store 132 of the remote system 130 may temporarily buffer the ASI in the course of transferring it to the fourth user device 112.

The first user device 106 may also send the ASI to the remote system 130 for “cold storage” in the data store 132 (for the illustrative reasons described later). The first user device 106 may then retrieve that instance of the ASI from the data store 132 at a later time, as represented by the path 140. The instance of the ASI enables the first user device 106 to resume operation of the application A1 at a later time, from the same point of application flow at which the application A1 was suspended.

As will be described more fully in Subsection A.3 below, the migration functionality performs a decision process to determine what instances of ASI should be transferred. The particular transfers shown in FIG. 1 reflect the outcome of that decision process. The decision process may include multiple components or parts. For instance, the migration functionality can determine when it is appropriate for a first user device (e.g., the first user device 106) to transfer one or more instances of ASI to other user devices. The migration functionality can also determine what other user devices are appropriate recipients for the ASI produced on the first user device 106. The migration functionality can also determine how to transfer the ASI to the recipient user device(s), e.g., whether to use direct transfer (and if so, what type), or whether to use an indirect route (and if so, what type). The migration functionality can also determine what components of ASI should be transferred to each of the other user devices, and so on. The above-described parts or aspects of the decision process are cited by way of example, not limitation; other implementation can include a different subset of decisions.

The migration functionality makes the above decisions with the overall objective of increasing the efficiency of information transfer. This objective, in turn, is useful to reduce the amount of information that is transferred between user devices. As an ancillary benefit, this objective reduces the amount of processing, storage, battery, and communication resources consumed by the transfers.

Generally, the migration functionality improves the efficiency of information transfer by identifying a priority level of each candidate transfer, and choosing a subset of transfers having the highest priority levels (and potentially ignoring a subset of other transfers having lower priority levels). That is, not all user devices are appropriate recipients of the ASI for a particular application, at a particular time. The migration functionality leverages this insight by refraining from sending the ASI to these user devices, at least immediately. The migration functionality further improves the efficiency of information transfer by judicially selecting the components of the ASI to be sent to the other user devices, the modes of communication to be used to perform the transfers, and so on.

For example, in the context of FIG. 1, the migration functionality may determine that it is appropriate to immediately transfer the ASI for application A1 to the second user device 108 and the fourth user device 112, but not to the third user device 110. For example, the migration functionality may determine that it is inappropriate to send the ASI to the third user device 110 because the user never uses (or rarely uses) the application A1 on the third user device 110. Therefore, it is unlikely that the user will resume the application A1 on the third user device 110. Alternatively, or in addition, the migration functionality may observe that the third user device 110 is not located in physical proximity to the first user device 106 at the current time. Therefore, the migration functionality may conclude that it is unlikely that the user is capable of immediately resuming interaction with the application A1 on the third user device 110. However, the migration functionality may opt to transfer the ASI for the application A1 to the third user device 110 at a later time, presuming that it is likely that the user will want to resume interaction with the application A1 on the third user device 110 at that later time.

The migration functionality may opt to directly send the ASI to the second user device 108 (via the path 136) based on the conclusion that the first user device 106 is in physical proximity to the second user device 108; such direct transfer may be advantageous, compared to indirect transfer, to avoid the communication cost of sending the ASI over the computer network 134. On the other hand, the migration functionality may opt to send the ASI to the fourth user device 112 via the computer network 134 (via path 138) based on a conclusion that direct transfer is not available or is otherwise less preferable than indirect transfer for this user device 112.

Advancing now to FIG. 3, the migration functionality can be conceptualized as including at least two basic components: decision logic and sync logic. The decision logic makes the above-described decisions pertaining to the transfer of instances of ASI among user devices. The sync logic performs the actual task of capturing ASI, transferring ASI, and resuming applications based on the ASI.

More specifically the above functions can be implemented within an environment by different distributed instances of the migration functionality. FIG. 3 only shows one such instance of migration functionality 302. The instance of migration functionality 302 may include, or may be conceptualized as including, an intelligence component 304 and a sync component 306. Other instances include their own instances of an intelligence component and a sync component. The intelligence component 304 performs the above-described decision-making functions, while the sync component 306 performs the above-described ASI transfer functions.

More specifically, the intelligence component 304 makes its decision(s) based on factor information. The factor information describes the context in which a user device, which runs a particular application, is being operated at a current time. The factor information, in turn, may include at least behavior-related information and environment-related information. The behavior-related information describes the prior behavior of the user that may be pertinent to the decision(s) made by the intelligence component 304. The environment-related information describes any environmental characteristics regarding the user's current interaction with an application that may be pertinent to the decision(s) made by the intelligence component. Subsection A.3 provides further illustrative details regarding the illustrative composition and use of the behavior-related information and the environment-related information.

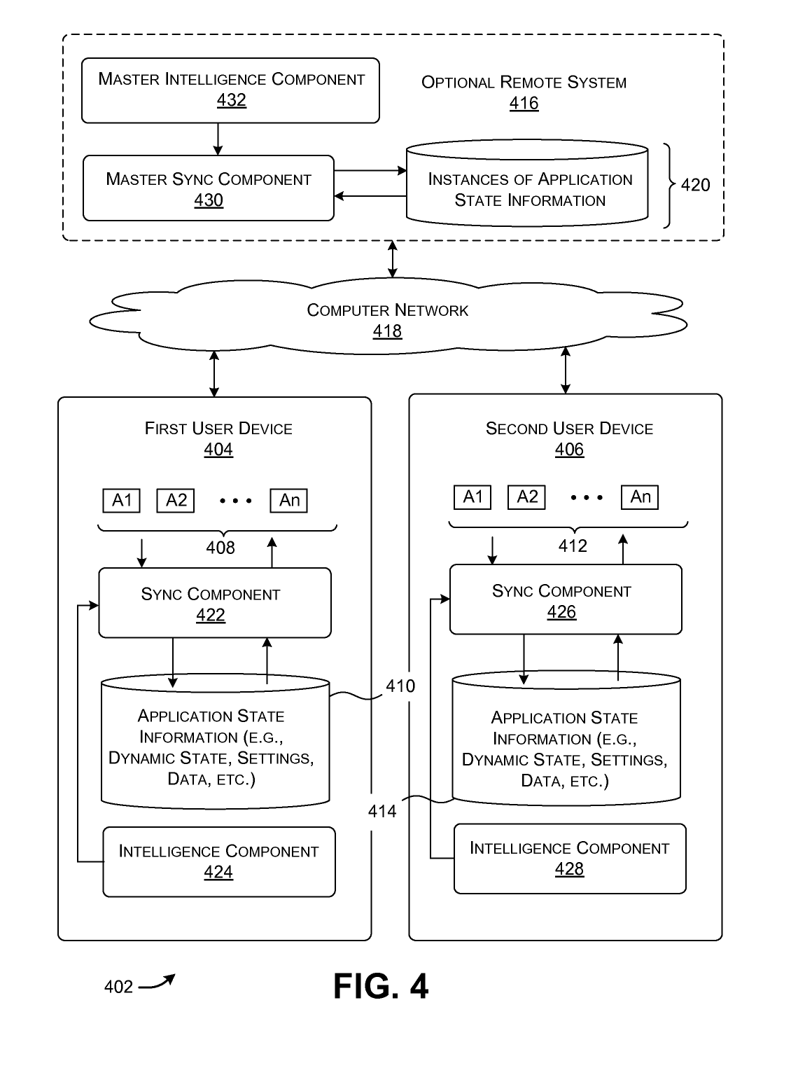

FIG. 4 shows an example of an environment 402 that implements the migration functionality. That is, for simplicity, FIG. 4 shows only the use of a first user device 404 and a second user device 406, although the environment 402 can include any number of user devices. FIG. 4 also indicates that the first user device 404 includes a collection of applications 408, and a data store 410 for storing instances of ASI pertaining to the applications that are running at any given time. Similarly, FIG. 4 indicates that the second user device 406 includes a collection of applications 412, together with a data store 414 for storing instances of ASI pertaining to the applications that are running at any given time.

Further, FIG. 4 shows the use of a remote system 416 which is coupled to the user devices (404, 406) via a computer network 418. The remote system 416 may include a data store 420 for storing instances of ASI, received from any of the user devices (404, 406). The remote system 416 is identified as optional in FIG. 4, indicating that it can be optionally omitted in some implementations.

The environment 402 provides multiple instances of the type of migration functionality 302 shown in FIG. 3, distributed over plural devices. For instance, the first user device 404 includes a first instance of migration functionality, made up of a sync component 422 and an intelligence component 424. The second user device 406 includes a second instance of migration functionality, made up of a sync component 426 and an intelligence component 428. If used, the remote system 416 may include a third instance of migration functionality, made up of a master sync component 432 and a master intelligence component 432. Hence, the migration functionality as a whole collectively includes the separate sync components (422, 426, 430) and the separate intelligence components (424, 428, 432). That is, the sync components (422, 426, 430), or any part thereof, constitute sync logic, while the intelligence components (424, 428, 432), or any part thereof, constitute intelligence logic.

The migration functionality can be applied in different ways, corresponding to different respective implementations. In a first mode of operation, each user device employs its local intelligence component to determine whether it is appropriate to transfer an instance of ASI to other user devices, and, if so, the manner in which this transfer is to take place. For example, the first user device 404 uses its intelligence component 424 to determine whether it is appropriate to transfer instances of ASI, pertaining to any of its running applications 408, to the second user device 406. The second user device 406 uses its local intelligence component 428 to determine whether it is appropriate to transfer instances of ASI, pertaining to any of its running applications 412, to the first user device 404.

The first intelligence component 424 may receive factor information (e.g., behavior-related information and/or environment-related information) from various sources. For example, some factor information may originate from sources associated with the first user device 404 itself. Other factor information may originate from the intelligence component 428 of the second user device 406, and/or the master intelligence component 432 of the remote system 416 (if used). Similarly, the second intelligence component 428 may receive factor information from various sources. For instance, some factor information may originate from sources associated with the second user device 406 itself. Other factor information may originate from the intelligence component 424 of the first user device 404, and/or the master intelligence component 432 of the remote system 416 (if used), and so on.

To be more concrete, in one example, assume that the intelligence component 424 of the first user device 404 seeks to determine whether it is appropriate to transfer an instance of ASI associated with one of its running applications 408 (such as application A1) to the second user device 406. To make this determination, the first intelligence component 424 can determine the usage patterns that describe the user's prior use of the application A1 on the second user device 406. That information, in turn, may be sent to the intelligence component 424 of the first user device 404 from the intelligent component 428 of the second user device 406. Or that information may originate from the master intelligence component 432 of the remote system 416, which, in turn, generates the information by observing the user's interaction with the second user device 406. Or the master intelligence component 432 may receive pattern information that has already been generated by the second user device 406. The second intelligence component 428 can perform a complementary operation to that described above when it seeks to determine the appropriateness of transferring an instance of ASI to the first user device 404.

The first sync component 422 can perform the actual task of transferring an instance of ASI from the first user device 404 to the second user device 406. Upon receipt, the second sync component 426 can use the ASI to resume an identified application at an appropriate resumption state defined by the ASI. Similarly, the second sync component 426 can transfer ASI to the first user device 404. Upon receipt, the first sync component 422 can use the ASI to resume an identified application at an appropriate resumption state defined by the ASI.

In summary, the above-described first mode of operation operates in a largely decentralized and distributed manner, insofar that each user device relies on its local instance of migration functionality to carry out the transfer and receipt of ASI information. Nevertheless, in this mode of operation, each local instance of migration functionality may receive factor information from other instances of migration functionality. In this sense, each local instance of migration functionality can be said to collaborate with other instances of migration functionality so as to intelligently manage the flow of ASI among the user devices.

The intelligence components can include instances of sharing functionality which accomplishes the above-described exchange of factor information. For instance, the instances of sharing functionality may exchange factor information in direct fashion (e.g., in peer-to-peer fashion) or via the computer network 134 and the remote system 416. For example, each instance of the sharing functionality can periodically, and/or on an event-driven basis, broadcast factor information to all other instances of the sharing functionality. In addition, or alternatively, the remote system 416 can host an instance of sharing functionality which manages the exchange of factor information among user devices.

A second mode of operation relies more heavily on the use of the migration functionality provided by the remote system 416. In that case, the master intelligence component 432 can receive factor information pertaining to the first user device 404 from the first intelligence component 424, and factor information pertaining to the second user device 406 from the second intelligence component 428. In that context, the first and second intelligence components (424, 428), provided by the first and second user devices (404, 406), serve the main function of collecting and transmitting factor information, rather than analyzing it. Based on the received factor information, the master intelligence component 432 can then determine when and how to transfer instances of ASI among the user devices (404, 406).

To carry out the actual transfer of instances of ASI in the second mode, the master intelligence component 432 can send appropriate instructions to the sync components (422, 426) of the affected user devices (404, 406). The sync components (422, 426) can then transfer the instances of ASI in the manner in which they are instructed. Alternatively, or in addition, the master sync component 430 can more directly carry out the transfer of ASI information, e.g., by collecting an instance of ASI from a source user device and sending it to a target user device.

The above two modes of operation are described by way of example, not limitation. Other implementations can deploy and utilize instances of migration functionality in other respective ways.

A.2. Illustrative Sync Component

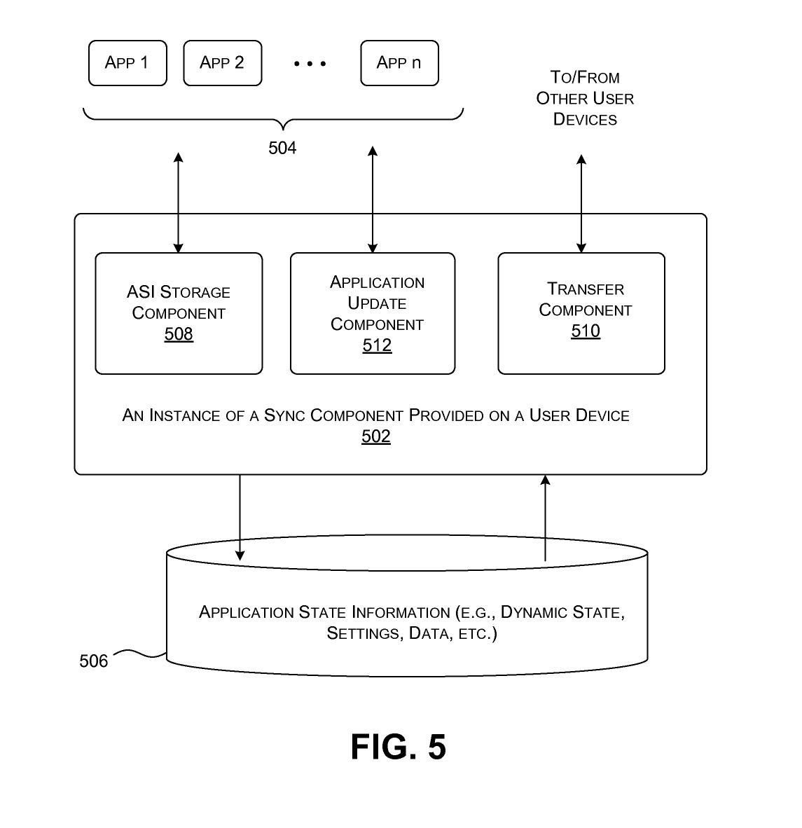

FIG. 5 shows one implementation of one sync component 502. Assume, for example, that a particular user device implements the sync component 502. The sync component 502 interacts with a collection of applications 504 and a data store 506 for storing instances of ASI. Other user devices may provide their own respective sync components (not shown). As described above, the remote system 416 may also provide a master sync component 430.

The sync component 502 may include, or may be conceptualized as including, a plurality of modules that perform different respective functions. Upon receiving an instruction from either a local or remote intelligence component, an ASI storage component 508 captures an instance of ASI pertaining to a particular application that is running on the user device. As described in Subsection A.1 above, an instance of ASI captures at least the dynamic runtime state of the application. In other cases, the ASI storage component 508 is instructed to capture multiple instances of ASI associated with multiple running applications. The ASI storage component may then store the instances of ASI that have been captured in the data store 506.

A transfer component 510 transfers an instance of ASI to another user device. As described above, the other user device may correspond to another physical computing device. In another case, the other user device may correspond to a virtual user device, such as a data store maintained by the remote system 130.

The transfer component 510 transfers the instance of ASI using a technique selected by an intelligence component. In one approach, the transfer component 510 may use a direct peer-to-peer technique to transfer the instance of ASI. In another approach, the transfer component 510 may send the instance of ASI via the remote system 416, which may entail buffering the ASI in the data store 420. The transfer component 510 can also function to receive instances of ASI from other user devices. The transfer component 510 may optionally buffer any such received instances of ASI in the data store 506.

An application update component 512 operates to use a received instance of ASI (that has been received by the transfer component 510 from another user device) to update a particular application. The application update component 512 may perform this task, in part, by retrieving the instance of ASI from the data store 506 and initializing appropriate memory stores, timer states, network connections, etc. based on the ASI.

Different environments can perform the above functions in different technology-specific manners. In one interaction flow, an application may use an event handler to detect the presence of a suspend signal, which may be sent by the operating system of the user device which is running the application to be suspended. In response to the receipt of the suspend signal, the application may carry out operations to store whatever information that it has been designed (by the application developer) to store upon receiving the suspend signal. That information includes, at a minimum, dynamic runtime state information pertaining to the application at an identified capture point. More specifically, in one case, the application may store the ASI by calling an application programming interface (API) provided by the ASI storage component 508. The ASI storage component 508 (which may be implemented by the operating system of the user device), then carries out the actual task of capturing the ASI and storing it in the data store 506.

An application resumes its operation based on a stored instance of ASI by performing complementary operations to those described above. For example, the application may use an event handler to detect the presence of a resume signal, which may be sent by the operating system of the user device on which the application is to be restored. The application may then call another API, which is hosted by the application update component 512. The application update component 512 responds to the call by retrieving the appropriate instance of ASI from the data store 506 and using it to restore the state of the application based on the information imparted by the ASI.

In one implementation, the sync component 502 performs all of the above operations by repurposing the suspend-and-resume functionality provided by a user device's operating system, such as the Windows® operating system provided by Microsoft® Corporation of Redmond Wash. As the suspend-and-resume functionality is normally used in its intended and traditional manner, a user may invoke a suspend operation by shifting focus from an application that is currently running on the user device to another application. In response, the operating system may store dynamic state information in a memory. The operating system may then use the dynamic state information to restore the state of the application when the user shifts his or her focus back to the suspended application. All of the above-described traditional operations take place with respect to the user's actions in interacting with the application on a single user device, such as a stationary PC.

In the case described in this subsection, the sync component 502 may store (at least) the same dynamic state information that is captured in the above-described type of normal suspend-and-resume operation described above. In addition, however, the sync component 502 may forward the dynamic state information to another user device, allowing the other user device to restore the running of application, as if it was suspended on that other user device. The sync component 502 also intelligently invokes the suspend-and-resume operations based on instructions from the intelligence logic of the migration functionality. Both such operations have no counterpart in traditional suspend-and-resume operations performed on a single user device.

As noted above, different user devices may host slightly different versions of the applications, e.g., to accommodate different processing architectures used by the different user devices, different form factors, etc. The implicit assumption being made above is that the ASI for an application that is running on a first user device can be successfully used to recreate the same dynamic runtime state of the same application on a second user device, even though the application running on the second user device may not be exactly the same as the application running on the first user device, and even though the underlying processing functionality provided by the second user device may not be the same as the underlying processing functionality provided by the first user device. For example, in the context of FIG. 2, the assumption is made that the positions of the game pieces captured by the application running on the first user device 202 correspond to meaningfully correct positions of the game pieces with respect to the same application to be resumed on the second user device 204.

Stated in other words, the assumption is made herein that the ASI information is device-agnostic or universal in nature, allowing it to be transferred and applied across different user devices. In those cases where this assumption does not apply in whole or in part, an application developer, or the migration functionality itself, can provide appropriate translation mechanisms which convert the ASI captured on a first user device to a compatible version of the ASI that may be consumed on another user device.

For example, an application running on a stationary PC may present a display having certain details; the same application running on a smartphone may omit some of those details to accommodate its smaller form factor. To address this issue, a translation mechanism can effective strip out or otherwise ignore any superfluous information in an instance of ASI, from the standpoint of the smartphone which will use that ASI to resume the application.

A.3. Illustrative Intelligence Component

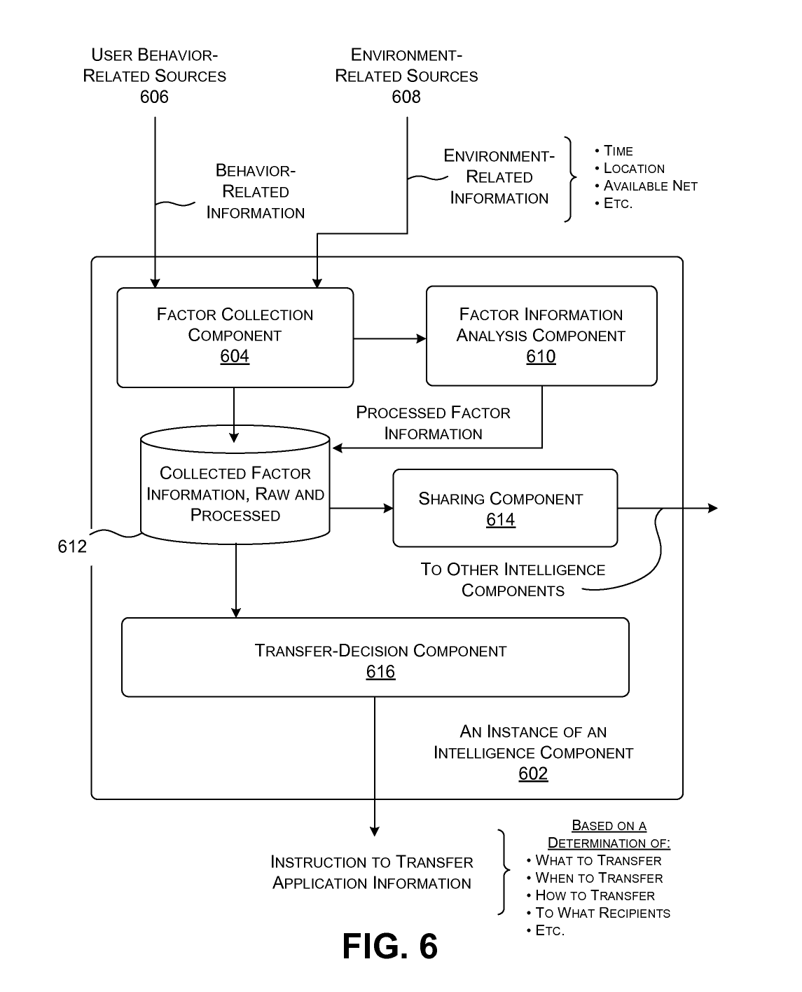

FIG. 6 shows an illustrative intelligence component 602. As described above, an intelligence component makes various decisions regarding the transfer of an instance of ASI from one device to another. In one case, an individual user device may host the intelligence component 602. In that context, the intelligence component 602 determines whether it is appropriate to transfer an instance of ASI from that user device (pertaining to the state of an application running on that user device) to another user device, with or without the assistance of any centralized intelligence provided by the remote system 416 (of FIG. 4). In other cases, the intelligence component 602 may correspond to the master intelligence component 432 hosted by the remote system 416 of FIG. 4. In that context, the intelligence component 602 makes decisions which apply to the user devices (404, 406) which it manages, with or without the assistance of any local intelligence provided by the local user devices (404, 406).

As a further introductory remark, FIG. 6 indicates that the intelligence component 602 includes, or may be conceptualized as including, plural modules which perform respective functions. In some cases, a distinct and unified physical component may indeed host all of the depicted modules. In other cases, the functions performed by the intelligence component 602 may be spread out over two or more individual physical modules. For example, a first physical component may collect factor information, and a second physical component may operate on the factor information.

In the following description, in the interest of simplicity, assume that a user is currently interacting with a particular user device (referred to as a “first user device” below); further assume that the user owns a collection of one or more other user devices of any type. In that context, the intelligence component 602 is tasked with the responsibility of determining the appropriateness of sending instances of ASI from the first device to one or more other devices. The instances of ASI pertain to applications that are running on the first device. But to further simplify the explanation, assume the intelligence component 602 is only asked to determine the appropriateness of sending ASI for one particular application under consideration. Finally, assume that the intelligence component 602 corresponds to logic hosted by the first device (although, as stated above, the intelligence component 602 could alternatively correspond to logic hosted by the remote system 416).

In the above scenario, a factor collection component 604 collects factor information that describes the context or circumstances in which the user is currently using the first user device. As already described above, the context information may have at least two informational components: behavior-related information and environment-related information. The behavior-related information, with respect to the particular application under consideration, describes the manner in which the user has consumed the application on prior occasions, and with respect to various user devices. The environment-related information describes the characteristics of the environment in which the user is currently interacting with the application. As will be described in Section C, the migration functionality can employ various privacy-related safeguards to ensure that it handles any user-related information in a manner that conforms to applicable laws of appropriate jurisdictions, social norms, and user expectations and preferences.

The behavior information may have one or more informational components, a representative collection of which is described below:

Temporal Usage Pattern Information.

The temporal usage pattern information describes the times at which the user has interacted with an application under consideration over some span of time, for various user devices owned by the user. More specifically, that temporal usage pattern information can express temporal information in any level of granularity. For example, the temporal usage pattern information can be expressed in terms of starting times at which the user started working on an application, on various user devices. The temporal usage pattern information can also describe the lengths of times that the user worked on the application, on various user devices. The temporal usage pattern information can also describe the user's general usage of different user devices, without specific reference to any particular applications that have been run the user devices.

Location Pattern Information.

The location pattern information describes the locations at which the user has interacted with the application, for various user devices owned by the user.

Activity Pattern Information.

The activity pattern information provides information that indicates the activities that the user was engaged in while interacting with an application, such as whether the user was stationary or moving while interacting with the application; that information, in turn, can be gleaned from various location-determination mechanisms, described below.

Joint Activity Information.

The joint activity information describes the conditional likelihood that a user will consume two or more applications at the same time, or in a particular sequence, with respect to each user device. The behavior information can provide such predictions by aggregating and linking together usage information associated with the user's consumption of individual applications.

Charging Habit Information.

The charging habit information describes the device-charging habits of the user, with respect to each user device that is powered by a battery.

Communication Mode Habit Information.

The communication mode habit information describes the habits and preferences of a user with respect to communication options, such as whether the user prefers to transmit data via WiFi or cellular channel, etc.

The factor collection component 604 may receive the behavior-related information from any number of sources 606. For example, the factor collection component 604 can receive time-based signals from the operating system of the first user device (which hosts the application under consideration); those temporal signals may identify the times at which the user begins interacting with the particular application on that user device. The temporal signals can also identify the amounts of time that the user has interacted with the application, on prior occasions. The temporal information can also describe the time-based conduct of a user with respect to the first user device itself, without reference to particular applications; for instance, the temporal signals can identify the times at which the user powered up the user device.

The factor collection component 604 can also receive location information from any location-determination mechanisms associated with, or otherwise available to, the first user device. Some of the location-determination mechanisms can provide absolute location information; other location-determination mechanisms can provide relative location information. An absolute location describes a position of the user device with respect to some established reference system (such as by providing latitude, longitude, and altitude readings). A relative location describes the position of the user device relative to some other user device or other object or reference point.

The location-determination mechanisms include, but are not limited to: accelerometers; gyroscopes; dead-reckoning mechanisms; signal strength detection mechanisms (e.g., which rely on the detection of the existence and strength of a signal provided by a single wireless signal source); triangulation mechanisms (e.g., which rely on the detection and processing of plural signals received from plural signal sources); satellite-based position-determination mechanisms (e.g., GPS), and so on. The factor collection component 604 can also receive movement information that reflects the movement of the first user device, e.g., based on signals received from that user device's accelerometer(s), gyroscope(s), etc.

The factor collection component 604 can also receive behavior-related information collected, and potentially processed, by other intelligence components. For example, the factor collection component 604 can receive behavior-related information supplied the intelligence component of another user device. In addition, or alternatively, the factor collection component 604 can receive behavior-related information from the master intelligence component 432 provided by the remote system 416.

As a final comment with respect to the behavior-related information, note that the above-described behavior-related information expresses the prior behavior of the particular user who is currently interacting with the application on the first user device. In addition, or alternatively, the factor collection component 604 can collect behavior-related information which describes general patterns and trends across a population of users, or across a sub-population of users who share one or more common characteristic with the present user (e.g., all male users in the age group 30-40, who currently resides in the Pacific Northwest of the United States).

The environment-related information may likewise have one or more informational components, a representative collection of which is described below:

Current Temporal Use Information.

The current temporal use information describes one or more temporal aspects of the user's current use of the application under consideration on the first user device. More specifically, the current temporal use information can describe the time (and date) at which the user logged onto the first user device, the time (and date) at which the user activated the application under consideration, and so on. The current temporal use information can also describe the amount of time that the user has been using the first user device and the application under consideration, within a current session.

Last Transfer Information.

The last transfer information describes the last time an instance of ASI, pertaining to the application under consideration, has been sent to other user devices.

Delta Information.

The delta information describes, for each recipient user device, the amount of data that has changed in the current instance of ASI, compared to the last instance of ASI that was sent to the recipient user device.

Application Identification Information.

The application identification information describes the application under consideration in any manner. For example, the environment-related information can provide an application ID associated with the application. In addition, or alternatively, the application identification information can describe the class (e.g., type) of application that has been activated. For example, if the application is a game application, the application pertains to a game class.

Number-of-Device Information.

The number-of-device information may describe the number of user devices owned by the user. The number-of-device information may also describe the number of user devices on which the application under consideration is installed. The number-of-device information may also describe the number of user devices on which the application is currently running. The number-of-device information can also describe the type(s) of user device(s) on which the user is running the application under consideration.

Absolute Location Information.

The absolute location information describes the current absolute location of the user device on which the user is currently consuming the application.

Relative Location Information.

The relative location information describes the relative location of the user device in contextual terms. For example, the relative location information can indicate whether the first user device is in relatively close proximity to any other user device, as defined by any distance-based metric.

The absolute location information and the relative location information can also describe the type of place at which the user is consuming the application, e.g., whether it is at work, at home, etc.; or the location information may reveal that the user is in transit, en route to a projected destination.

Device Characteristic Information.

The device characteristic information describes the current characteristics of the user device on which the application is being run. For example, the device characteristic information can include network availability information that describes the communication connection options that are currently available to the first user device, e.g., direct WiFi transfer, direct NFC communication, network-based WiFi, cellular (e.g., 3G, etc.), and so on. The device characteristic information can also include connection-stability information that describes the expected stability of at least one such connection between the first user device and at least one other user device, e.g., with respect to the length of time that the connection is expected to be maintained, the reliability of that connection, etc. In some cases, for instance, a user device may correspond to an always-on-always-connected device, corresponding to a device that remains in an active state for a relatively long period of time, and, while on, has a relatively stable and reliable connection to a network. In other cases, a user device may have only intermittent connection to a network. The device characteristic information may also include battery information that describes the relative battery level of the user device on which the application is being run. Similarly, the device characteristic information can also describe the above-described type of equipment-related capabilities of other user devices, which are candidates for receiving the ASI generated by the first user device.

The factor collection component 604 can receive the environment-related information from various sources 608. For example, the factor collection component 604 can receive time-based information from the operating system of the first user device (which is currently running the application). The factor collection component 604 can receive location information from any of the location-determination mechanisms described above. The factor collection component 604 can also receive equipment-capability information (such as battery level information) from the operating system, or other services, provided by the first user device.

The factor collection component 604 can also receive environment-related information that has been collected by, and potentially processed by, other intelligence components. For example, the factor collection component 604 can receive information which describes the equipment capabilities of another user device from the intelligence component of that other user device, and/or from the master intelligence component 432 that is hosted by the remote system 416.

The above-described collected factor information may, in some cases, correspond to raw information. A factor information analysis component (“analysis component” for brevity) 610 may process the raw factor information to produce processed factor information. For example, the analysis component can receive successive instances of time-based information that describe the starting times at which the user has used a particular application on the first user device, and the longevities of those interactions. The analysis component 610 can analyze this time-based information to detect patterns and trends in the user's manner of using the application on that user device. The analysis component 610 can then output information which identifies those patterns and trends.

The analysis component 610 can perform the above analysis using any techniques. For example, the analysis component 610 can compute an indication of the number of times that a user has used a particular application on a particular user device. In addition, or alternatively, the analysis component 610 can perform more complex analysis, such as Bayesian likelihood analysis, etc.

A data store 612 stores the factor information supplied by the factor collection component 604 and the analysis component 610. Such factor information may correspond to raw unprocessed factor information in some cases, and processed factor information in other cases.

A sharing component 614 may provide the factor information provided in the data store 612 to any other intelligence components, e.g., hosted by other user devices and/or the remote system 416. The sharing component 614 can perform this transfer based on a push-based manner of interaction (e.g., by periodically sending the factor information to the other components, without being requested by the other intelligence components). Alternatively, or in addition, the sharing component 614 can use a pull-based manner of interaction to transfer the factor information (e.g., by sending the factor information when requested to do so by the other intelligence components). In terms of the terminology used in Subsection A.1, the sharing component 614 is an example of sharing functionality, tasked with the responsibility of sharing intelligence among user devices in a collaborative manner.

A transfer-decision component 616 analyzes any of the factor information provided in the data store 612 to make transfer-related decisions. As described above, a transfer-related decision can have multiple components. As a first decision, the transfer-decision component 616 may determine what other devices should receive the ASI for the application under consideration, which is being run on the first user device. As a second decision, the transfer-decision component 616 can determine the time at which the transfer should be performed, with respect to each target user device. As a third decision, the transfer-decision component 616 can determine what type of ASI is to be sent to each target user device. For example, in most cases, the transfer-decision component 616 may decline to send executable information (e.g., the binaries of the application) to the target user device; but in certain cases, the transfer-decision component 616 can also send the binaries, along with the dynamic runtime state information. In other words, in some cases, the executable information of an application may be considered as another component of the ASI that is transferred. As a fourth decision, the transfer-decision component 616 can determine the manner to be used to send the ASI to each target user device, e.g., by either using a type of direct peer-to-peer transfer, or by using a network-based transfer of information, etc.

The transfer-decision component 616 can make the above-described decisions by using any decision algorithm or technique. In one case, for instance, the transfer-decision component 616 can make the above decisions in a rule-based manner. Each rule maps a set of factors into a conclusion as to whether an instance of ASI should be transferred to a target user device, and, if so, how it should be transferred. Such rules can be embodied in a mapping table, a branching algorithm, etc. In other cases, the transfer-decision component 616 can rely on a machine-trained model of any type to make the above transfer-related decisions.

Different transfer rules may be appropriate for different environments, depending the characteristics of the environment and the particular objectives being sought in that environment. The remainder of this subsection will provide examples of decisions that may be made in one particular environment. Such examples are described in the spirit of illustration, not limitation; in other environments, other rules may be adopted, including rules which may differ or even contradict the rules described below.

### First Example

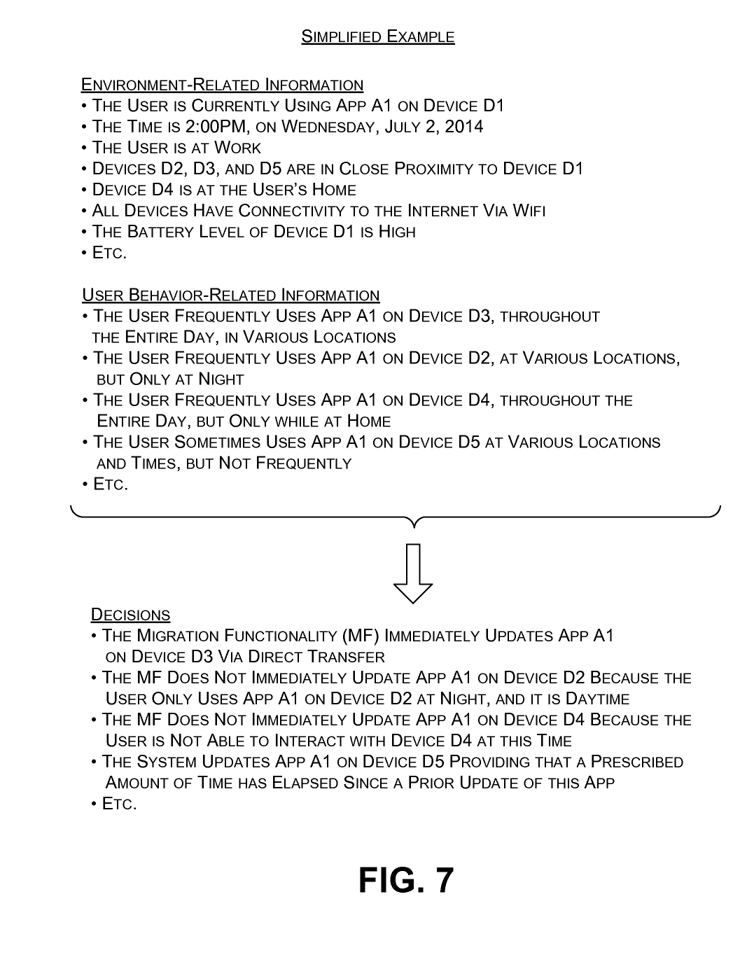

First consider the simplified example outlined in FIG. 7. In that example, the user owns five user devices, represented by the respective symbols D1, D2, D3, D4, and D5. The user is currently using device D1.

More specifically, the environment-related information that is collected indicates that the user is currently using application A1 on device D1 at his place of work, at 2:00 PM on a workday (Tuesday), within a summer month. The environment-related information also reveals that devices D2, D3, and D5 are in close proximity to the device D1. For example, the devices D1, D2, D3, and D5 may all be present in the user's office at work. The environment-related information, however, may indicate that the user device D4 is at the user's home. The environment-related information may also indicate that the battery level of the user device D1 is sufficiently high, relative to some specified threshold. Finally, the environment-related information indicates that all user devices have connectivity to the Internet at the present time via some mechanism, such as WiFi. The environment-related information may also indicate that the user device D1 can communicate with any of the nearby user devices (e.g., D2, D3, and D5) via at least one direct peer-to-peer technique, such as a near field communication (NFC), Bluetooth™ communication, direct WiFi communication, etc.

The behavior-related information may indicate that the user frequently uses the application A1 on devices D3 throughout the day at various locations. The behavior-related information may also indicate that the user frequently uses the application A1 on the device D2 at various locations, but only during nighttime hours. The behavior-related information may also indicate that the user frequently uses the application A1 on the device D4 throughout the day, but only at home. Finally, the behavior-related information may indicate that the user sometimes uses application on device D5 at various locations, but not very frequently.

The migration functionality (MF) takes the following illustrative and non-limiting actions on the basis of the above-described factors. (The migration functionality may correspond, in part, to the intelligence component associated with the user device D1 and/or the master intelligence component 432 associated with the remote system 416). First, the migration functionality immediately updates the application A1 on the device D3 via direct peer-to-peer information transfer. The migration functionality opts for direct transfer to reduce the traffic over the computer network 418, and any performance-related issues and costs associated therewith.

The migration functionality does not immediately update the application A1 on the device D2 because the user only uses the application A1 on the device D2 at night, whereas it is presently a daytime hour. Similarly, the migration functionality does not immediately update the application A1 on the device D4 because the user only uses the application A1 on device D4 at home, whereas the user is presently at work. However, the migration functionality may decide to cache the ASI and transfer it at a later time to these two user device (D2, D4), closer to the time at which the user is expected to consume it. More specifically, the migration functionality may store several instance of the ASI leading up to the point at which transfer is deemed appropriate; at that time, the migration functionality may transmit all of the instances of ASI or only the most recent instance of ASI, assuming that the most recent instance of ASI completely captures the most recent state of the application A1 on the user device D1. Or the migration functionality can aggregate the multiple instances of ASI and transmit that aggregated information to the target user devices as a single message.

Finally, the migration functionality updates the application A1 on the user device D5, but not necessarily immediately. More specifically, the migration functionality updates the user device D5, with respect to the application A1, at a low frequency rate. Hence, the migration functionality determines whether a sufficient amount of time has occurred since it last updated the user device D5 with respect to the application A1; if so, then the migration functionality updates the user device D5, and, if not, then the migration functionality holds off on updating the user device D5. The potential delay in updating the user device D5 is appropriate in this case because there is a low probability that the user will be interacting with the application A1 on the device D5, based on his prior conduct. Note that updating a user device that rarely uses an application A1 may also be deemed beneficial to achieve fault tolerance and other objectives.

Overall, the migration functionality operates to immediately update application A1 on some user devices, but not other user devices. As a result, the user will enjoy synchronized content on the user devices on which he or she is most likely to continue interaction with the application A1. As a further consequence, the migration functionality reduces the amount of unnecessary or wasteful updates, saving communication, processing, and storage resources.

### Second Example

In another case, the migration functionality may frequently update an application A1 on target user devices when it determines that the first user device (e.g., the user device D1) has a relatively high battery level (assuming that other applicable transfer conditions have also been met). This decision is based on the assumption that the battery is not likely to become depleted any time soon, and therefore, the frequent updates are not likely to adversely affect the operability of the user device D1 any time soon. The migration functionality can also take into consideration the battery level of each target user device that will receive the ASI.

In another situation, the migration functionality may determine that the battery level on the user device D1 is very low, relative to some threshold. The migration functionality may decide to immediately update all user devices that host the application A1, under the premise that the user will likely soon wish to switch to another user device. A very low battery level on any target device may also cause the migration functionality to immediately update the application A1 on that user device, regardless of the battery level of the source user device (e.g., the user device D1).

The above-described battery-level-based scenarios are illustrative, rather than limiting. That is, other environments can respond to the battery levels of the user devices in other environment-specific ways.

### Third Example

In another case, the migration functionality may determine that the user is about to run out of storage space on the user device D1 on which to store additional applications. In response, the migration functionality can identify the application that the user least frequently uses on the user device D1. The migration functionality can then send an instance of ASI associated with that application to the remote data store 420 of the remote system 416 for “cold storage” thereat. More specifically, the ASI in this case can include the executable files of the application, in addition to its dynamic runtime state and other information (that is, if the application happened to be running at the time of migration, or the state is otherwise preserved by the application). Suppose next that the user later wished to run an application that has been moved to cold storage. If the user device D1 has sufficient storage capacity at that time, the migration functionality can move the ASI of the application back to the device D1, whereupon the user device D1 can run the application.

### Fourth Example

The above-described scenarios are predicated on the assumption that the migration functionality can accurately predict the usage habits of the user, and proactively update applications in a manner that conforms to the user's known habits. In certain cases, however, the user may interact with an application in a manner that does not conform to his or her prior conduct. For example, in the scenario set forth in FIG. 7, a user may decide to use the user device D2 to interact with the application A1 during the day, while he usually interacts with the application A1 using device D2 at night. In response to this conduct, the migration functionality can update the application A1 on the user device D2 in a reactive on-demand manner (instead of proactively). The migration functionality can also update its information regarding the habits of the user, to indicate that, on at least one observed occasion, the user used application A1 on device D2 during the day.

### Fifth Example

In some cases, the user may wish to interact with an application on two or more user devices at the same time. The migration functionality may be able to predict the user's behavior, assuming that the user has engaged in this type of conduct on prior occasions. In response, the migration functionality can transfer instances of ASI to these user devices just prior to the point at which the user is expected to run the application on them. Thereafter, the migration functionality can be used to swap instances of ASI among the running applications, to ensure that each user device is up to date relative to other user devices that are running the same application. The migration functionality can also send appropriate instances of ASI from the two or more user devices that are running the application to other user devices that the user may wish to interact with next.

### Sixth Example

In another case, the first user device D1 may correspond to an always-on-always-connected user device having a reliable and stable connection to other user devices, e.g., through the computer network 418 or by some other mechanism(s). The migration functionality can leverage the reliable status of the first user device by holding off on sending periodic ASI updates to other user devices, that is, until that time that the migration functionality predicts that one or more target user devices will actually need the ASI.

B. Illustrative Processes

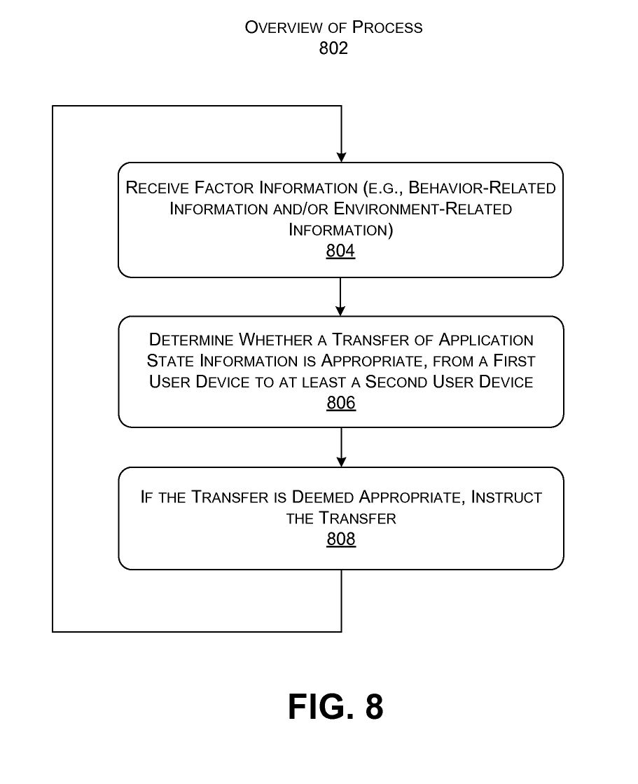

FIG. 8 shows a process 802 that explains the operation of the migration functionality of Section A in flowchart form. Since the principles underlying the operation of the migration functionality have already been described in Section A, certain operations will be addressed in summary fashion in this section.

In block 804, the migration functionality receives factor information that describes a context in which a user is using an application on a first user device. In block 806, the migration functionality determines, based on the factor information, whether to transfer application state information (ASI) from the first user device to at least a second user device. The migration functionality can also determine when to transfer the application state information, how to transfer the application state information, what components of the application state information to be sent, etc. In block 808, the migration functionality sends an instruction which commands a sync component to transfer the application state information from the first user device to the second user device, providing that a determination is made that the transfer is appropriate.

As described in Section A, the application state information captures at least a dynamic runtime state of the application on the first user device, at a point of capture of the dynamic runtime state. (The application state information may also include any other components set forth above, such as setting information, data, execution information, etc.). As another illustrative feature, the migration functionality is implemented by one or more computing devices in a manner that is agnostic with respect to the nature of the application that is being transferred, and to the nature of the application state information itself.

The factor information may include any combination of the behavior-related information items described in Section A and/or any combination of the environment-related information items described in Section A.

C. Representative Computing Functionality

FIG. 9 shows computing functionality 902 that can be used to implement any aspect of the migration functionality set forth in the above-described figures. For instance, the type of computing functionality 902 shown in FIG. 9 can be used to implement any user device, the remote systems (130, 416), etc. In all cases, the computing functionality 902 represents one or more physical and tangible processing mechanisms.

The computing functionality 902 can include one or more processing devices 904, such as one or more central processing units (CPUs), and/or one or more graphical processing units (GPUs), and so on.

The computing functionality 902 can also include any storage resources 906 for storing any kind of information, such as code, settings, data, etc. Without limitation, for instance, the storage resources 906 may include any of RAM of any type(s), ROM of any type(s), flash devices, hard disks, optical disks, and so on. More generally, any storage resource can use any technology for storing information. Further, any storage resource may provide volatile or non-volatile retention of information. Further, any storage resource may represent a fixed or removable component of the computing functionality 902. The computing functionality 902 may perform any of the functions described above when the processing devices 904 carry out instructions stored in any storage resource or combination of storage resources.

As to terminology, any of the storage resources 906, or any combination of the storage resources 906, may be regarded as a computer readable medium. In many cases, a computer readable medium represents some form of physical and tangible entity. The term computer readable medium also encompasses propagated signals, e.g., transmitted or received via physical conduit and/or air or other wireless medium, etc. However, the specific terms “computer readable storage medium” and “computer readable medium device” expressly exclude propagated signals per se, while including all other forms of computer readable media.

The computing functionality 902 also includes one or more drive mechanisms 908 for interacting with any storage resource, such as a hard disk drive mechanism, an optical disk drive mechanism, and so on.

The computing functionality 902 also includes an input/output module 910 for receiving various inputs (via input devices 912), and for providing various outputs (via output devices 914). Illustrative input devices include a keyboard device, a mouse input device, a touchscreen input device, a digitizing pad, one or more video cameras, one or more depth cameras, a free space gesture recognition mechanism, one or more microphones, a voice recognition mechanism, any movement detection mechanisms (e.g., accelerometers, gyroscopes, etc.), and so on. One particular output mechanism may include a presentation device 916 and an associated graphical user interface (GUI) 918. Other output devices include a printer, a model-generating mechanism, a tactile output mechanism, an archival mechanism (for storing output information), and so on. The computing functionality 902 can also include one or more network interfaces 920 for exchanging data with other devices via one or more communication conduits 922. One or more communication buses 924 communicatively couple the above-described components together.

The communication conduit(s) 922 can be implemented in any manner, e.g., by a local area network, a wide area network (e.g., the Internet), point-to-point connections, etc., or any combination thereof. The communication conduit(s) 922 can include any combination of hardwired links, wireless links, routers, gateway functionality, name servers, etc., governed by any protocol or combination of protocols.

Alternatively, or in addition, any of the functions described in the preceding sections can be performed, at least in part, by one or more hardware logic components. For example, without limitation, the computing functionality 902 can be implemented using one or more of: Field-programmable Gate Arrays (FPGAs); Application-specific Integrated Circuits (ASICs); Application-specific Standard Products (ASSPs); System-on-a-chip systems (SOCs); Complex Programmable Logic Devices (CPLDs), etc.

In closing, the functionality described herein can employ various mechanisms to ensure that any user data is handled in a manner that conforms to applicable laws, social norms, and the expectations and preferences of individual users. For example, the functionality can allow a user to expressly opt in to (and then expressly opt out of) the provisions of the functionality. The functionality can also provide suitable security mechanisms to ensure the privacy of the user data (such as data-sanitizing mechanisms, encryption mechanisms, password-protection mechanisms, etc.).

More generally, although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, implemented by one or more computing devices, for efficiently migrating application state information, comprising:
receiving factor information that describes a context in which a user is using an application on a first user device;
determining, based on the factor information, whether to transfer application state information from the first user device to at least a second user device; and
instructing the transfer of the application state information from the first user device to the second user device, providing that a determination is made that the transfer is appropriate,
the application state information capturing at least a dynamic runtime state of the application on the first user device, at a point of capture of the dynamic runtime state, and
said receiving, determining, and instructing utilizing migration functionality that is implemented by said one or more computing devices in a manner that is agnostic with respect to a nature of the application that is being run on the first user device, and agnostic with respect to a nature of the application state information.

2. The method of claim 1, wherein the first user device is different from the second user device.

3. The method of claim 1, wherein the first user device and the second user device refer to different instances of the same user device at different respective times.

4. The method of claim 1, wherein the application state information represents a part of a total amount of state information associated with the first user device, the part being less than the total amount of state information.

5. The method of claim 1, wherein the receiving, determining, and instructing are performed using migration functionality provided, at least in part, on the first user device.

6. The method of claim 1, wherein the receiving, determining, and instructing are performed using migration functionality provided, at least in part, by a remote system that is remotely located from the first user device and the second user device.

7. The method of claim 1, wherein the transfer of the application state information takes place via a direct peer-to-peer path from the first user device to the second user device.

8. The method of claim 1, wherein the transfer of the application state information takes place via a communication path that involves interaction with a remote system, the remote system being remotely located from the first user device and the second user device.

9. The method of claim 1, wherein the factor information includes:
behavior-related information that describes prior behavior of the user in consuming the application on different respective user devices; and
environment-related information that describes environmental conditions in which the user is currently using the application on the first user device.

10. The method of claim 9, wherein the behavior-related information identifies temporal patterns of interaction with the application, by at least the user, on different respective user devices.

11. The method of claim 9, wherein the behavior-related information identifies location-based patterns of interaction with the application, by at least the user, on different respective user devices.

12. The method of claim 9, wherein the environment-related information describes at least one temporal aspect of a current use of the application on the first user device, by the user.

13. The method of claim 9, wherein the environment-related information identifies an absolute location of the first user device.

14. The method of claim 9, wherein the environment-related information identifies a relative location of the first user device that is relative to other user devices.

15. The method of claim 9, wherein the environment-related information indicates one or more mechanisms available to the first user device to communicate with other user devices.

16. The method of claim 9, wherein the environment-related information describes an expected stability of at least one connection between the first user device and at least one other user device.

17. The method of claim 9, wherein the environment-related information identifies a battery level of the first user device.

18. One or more computing devices for implementing migration functionality, comprising:
at least one factor collection component configured to receive factor information that describes a context in which a user is using an application on a first user device,
the factor information including:
behavior-related information that describes prior behavior of the user in consuming the application on different respective user devices; and
environment-related information that describes environmental conditions in which the user is currently using the application on the first user device;
at least one transfer-decision component configured to determine, based on the factor information:
(a) whether to transfer application state information from the first user device to at least a second user device;
(b) a time at which to transfer the application state information from the first user device to the second user device; and
(c) a communication mechanism with which to transfer the application state information from the first user device to the second user device; and
at least one sync component configured to transfer the application state information from the first user device to the second user device using a selected communication mechanism, providing that a determination has been made that the transfer is appropriate, and
the application state information capturing at least a dynamic runtime state of the application on the first user device, at a point of capture of the dynamic runtime state.

19. The one or more computing devices of claim 18, wherein the transfer-decision component is also configured to determine what component or components of application state information are to be transferred from the first user device to the second user device.

20. A computer readable storage medium for storing computer readable instructions, the computer readable instructions implementing migration functionality when executed by one or more processing devices, the computer readable instructions comprising:
factor collection logic configured to receive factor information that describes a context in which a user is using an application on a first user device,
the factor information including:
behavior-related information that describes prior behavior of the user in consuming the application on different respective user devices, corresponding to one or more of:
temporal patterns of interaction with the application, by the user, on different respective user devices; and/or
location-based patterns of interaction with the application, by the user, on different respective user devices;
environment-related information that describes environmental conditions in which the user is currently using the application on the first user device, corresponding to one or more of:
current temporal use information that describes at least one temporal aspect of a current use of the application on the first user device, by the user;
absolute location information that identifies an absolute location of the first user device;
relative location information that identifies a relative location of the first user device that is relative to other user devices;
network availability information that indicates one or more mechanisms available to the first user device to communicate with other user devices; and/or
battery information that describes a battery level of the first user device; and
transfer-decision logic configured to determine, based on the factor information, whether to transfer application state information from the first user device to at least a second user device,
the transfer-decision logic being also being configured to generate an instruction to transfer the application state information from the first user device to the second user device, providing that a determination is made that the transfer is appropriate.
